(19) United States
(12) Patent Application Publication
(10) Pub. No.: US 2005/0211740 A1
(43) Pub. Date: Sep. 29, 2005

(54) Apparatus for lifting, controlling and maneuvering a wheelbarrow

(76) Inventor: Zoran Ozren Sekulic, Beaverton, OR (US)

Correspondence Address: SMITH-HILL AND BEDELL, P.C., 16100 NW CORNELL ROAD, SUITE 220, BEAVERTON, OR, 97006, US

(21) Appl. No.: 10/811,122

(22) Filed: Mar. 25, 2004

(51) Int. Cl. A45F 3/14; B62B 1/00; B62B 7/02

(52) U.S. Cl. 224/258

(57) ABSTRACT

An apparatus for reducing the load on a wheelbarrow user's arms and assisting the user to lift and maneuver the wheelbarrow includes a pad residing on the user's shoulders, a strap passing through the and secured to wheelbarrow's handles and means for adjusting the length of the strap between the two wheelbarrow handles.

### BACKGROUND OF THE INVENTION

1. Field of the Invention

The present invention relates in general to lifting apparatus, and particularly to a lifting apparatus for assisting an operator to lift and maneuver a wheelbarrow.

2. Description of Related Art

A wheelbarrow is a simple cart commonly used to transport loads of materials over relatively short distances. A wheelbarrow typically has two handles, one wheel and a container and can be operated by a single person. Conventionally, using a wheelbarrow involves the following steps: loading material to be moved into the container, griping a handle with each hand and lifting the handles so the wheelbarrow's wheel and the operator's hands and arms are bearing the combined weight of the wheelbarrow and the material in the container. The operator may then push the wheelbarrow to the desired location where the container can be emptied.

A wheelbarrow bearing a particularly heavy load or is to be transported a relatively long distance or is to be lifted by a physically weak operator may be uncomfortable or unsafe for the operator's hands and arms to support and thus an apparatus for assisting in lifting and maneuvering a wheelbarrow is desirable.

Lifting harnesses, such as U.S. Pat. No. 2,651,441 issued Sep. 8, 1953 to Rau et al and U.S. Pat. No. 2,441,115 issued May 4, 1948 to Lambert, assist in lifting a variety of heavy loads and may provide a solution transferable to wheelbarrows.

Prior art wheelbarrow accessories attempt to preserve the advantages of the basic wheelbarrow while enhancing control and power. U.S. Pat. No. 5,346,232 issued Sep. 13, 1994 to Bushon proposes to solve the lifting requirements of a common wheelbarrow by placing a strap between the handles to be pushed with the operator's thigh muscles. Long-term use of this device would repetitively exert pressure on a narrow area of the operator's thigh, potentially making the device uncomfortable or unsafe to use.

U.S. Pat. No. 915,628 issued Mar. 16, 1909 to Seymore describes an apparatus employing a series of pulleys mounted upon a yoke. A rope or cable runs through the pulleys and has hooks on either end for attaching to the handles of a wheelbarrow. This apparatus does not provide any means of adjustment for operators or wheelbarrows of varying sizes and the pulley system is susceptible to rusting or becoming jammed with dirt and debris. Further, the yoke of this apparatus is made of a rigid material surrounding a large portion of the operator's neck, raising safety concerns in a modern work environment.

What is needed is an apparatus capable of safely transferring the weight of a wheelbarrow away from the operator's hands and arms both for the sake of comfort and so the hands can be better used to safely maneuver the wheelbarrow.

### SUMMARY OF THE INVENTION

According to an embodiment of the invention there is an apparatus for assisting in lifting and maneuvering a wheelbarrow having first and second handles, the apparatus comprising a strap, a first engagement means secured to the strap for engaging the first handle of the wheelbarrow, a second engagement means secured to the strap for engaging the second handle of the wheelbarrow, and a means for adjusting a distance along the strap separating the first and second engagement means.

According to another embodiment of the invention there is an apparatus for assisting in lifting and maneuvering a wheelbarrow having first and second handles, the apparatus comprising a strap having a first end and a second end, first engagement means secured to the strap for engaging the first handle of the wheelbarrow, second engagement means secured to the strap for engaging the second handle of the wheelbarrow, and a flexible pad attached to the length of the strap.

According to another embodiment of the invention, there is an apparatus for assisting in lifting and maneuvering a wheelbarrow having first and second handles, the apparatus comprising a lifting strap, and a first buckle through which the strap is threaded to define a first loop for engaging the first handle of the wheelbarrow.

### BRIEF DESCRIPTION OF THE DRAWINGS

FIG. 1 is a side view of a wheelbarrow being lifted with the aid of a lifting apparatus embodying the present invention.

FIG. 2 is a perspective view of the apparatus shown in FIG. 1.

FIG. 3 is a perspective view of a detail of a second lifting apparatus embodying the present invention.

FIG. 4 is a front view of a third lifting apparatus embodying the present invention.

### DETAILED DESCRIPTION

As shown in FIG. 1, a conventional wheelbarrow 2 includes handles 4, a container 8 disposed above the handles, legs 12 mounted below the handles and wheel 16 connected to the handles via an axle assembly 18. When in a resting position, wheel 16 and legs 12 form a tripedal support for container 8. To transport wheelbarrow 2, operator 20 grasps grips 22 of handles 4 and lifts them to a convenient height, causing the wheelbarrow to pivot around the rotational axis of axle assembly 18 so that legs 12 rise off the ground. Wheel 16 is free to rotate, allowing operator 20 to push wheelbarrow 2 to the desired destination. Operator 20 discharges the contents of container 8 by rotating handles 4, for example by lowering the left handle and raising the right handle, causing wheelbarrow 2 to rotate with respect to the point where wheel 16 contacts the ground (not shown).

Referring to FIG. 2, the illustrated lifting apparatus comprises a strap 32 of fabric webbing threaded through rectangular passage 43 in a length of flexible tubular padding 44. Padding 44 may be composed of a resilient foam material. Each end of strap 32 is threaded through an adjustable locking buckle 40, an eye 39 of a hook 36, and back through the buckle. Buckle 40 is a conventional buckle that includes a releasable locking mechanism.

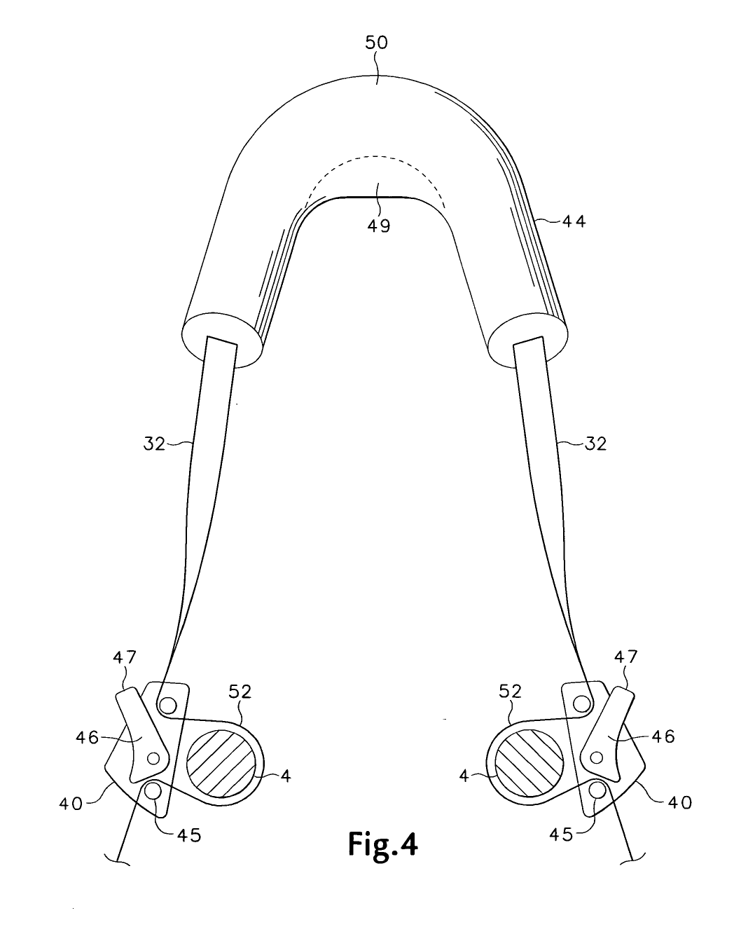

Referring to FIG. 4, the locking mechanism of illustrated buckle 40 comprises toothed barrel 45 and a toothed cam 46. Toothed cam 46 is pivotable, relative to the barrel, between an engaged position, for allowing strap 32 to move relative to the buckle in only a tightening, or shortening, direction, and a released position, for allowing the strap to move both in the tightening direction and in a loosening, or lengthening, direction. Pulling strap 32 in the loosening direction when cam 46 is in the engaged position jams the strap between barrel 45 and the cam, preventing movement of the strap. A lever 47 assists in moving cam 46 to the released position. A spring (not shown) holds cam 46 in the engaged position unless operator 20 depresses the lever 47.

Referring again to FIG. 1 the lifting apparatus assists operator 20 by transferring the load to be supported by the operator from operator's hands 24 to operator's shoulders and back 28. To use the lifting apparatus, operator 20 would pre-adjust the effective length of strap 32, i.e. the distance between hooks 36, using adjustable locking buckles 40. In use the appropriate effective length will vary by situation, but it can be estimated by placing strap 32 around the back of the operator's neck, with padding 44 centered approximately on the spine. The free ends of strap 32 should then be hanging in front of operator's arms 24. Each end should be adjusted so hooks 36 hang slightly below the operator's fingertips when the arms are at the sides.

To engage wheelbarrow 2 with the apparatus, the operator stands between handles 4 and places strap 32 on the operator's neck with padding 44 centered on the spine. If hooks 36 can reach handles 4 while the operator is standing upright, the effective length of strap 32 is too great and must be reduced. After ensuring the effective length of strap 32 is properly adjusted, the operator bends or squats down in order to lower hooks 36 and temporarily engage them with handles 4 while maintaining slack in the strap. It will be appreciated that once the effective length of strap 32 has been adjusted for the particular operator and the particular wheelbarrow, it will not generally be necessary to change the adjustment.

When hooks 36 are engaged with handles 4, operator 20 begins to stand, taking hold of grips 22 to aid in balancing wheelbarrow 2. When strap 32 becomes taut legs 12 of wheelbarrow 2 lift off the ground and a significant portion of the weight of the wheelbarrow will be transferred through the strap to operator's shoulders and back 28. Padding 44 on strap 32 distributes the load across a greater surface area of operator's shoulders and back 28 for the operator's comfort. When lifting the wheelbarrow, the operator preferably will lift by straightening at the knees and hips, keeping the back as upright as possible so as to reduce the possibility of injury. By transferring the weight of wheelbarrow 2 to the operator's shoulders and back through strap 32, the operator uses the strongest muscles to lift the wheelbarrow and is better able to use hands and arms to aid in balancing and maneuvering the wheelbarrow. Thus the lifting apparatus can enable the operator to lift heavier loads.

Discharging the contents of wheelbarrow 2 is performed in the conventional manner described above. When operator 20 raises one handle above the other strap 32 will move through passage 43 of padding 44 while the padding remains in place on the neck of the operator.

Hooks 36 may be sized to fit snugly on wheelbarrow handles 22 so that they remain on handles 22 when operator 20 releases tension on strap 32. Alternatively, the ends of hooks 36 may be designed so that their ends extend partially over the tops of handles 22 so that they remain on the handles when operator 20 releases tension on strap 32.

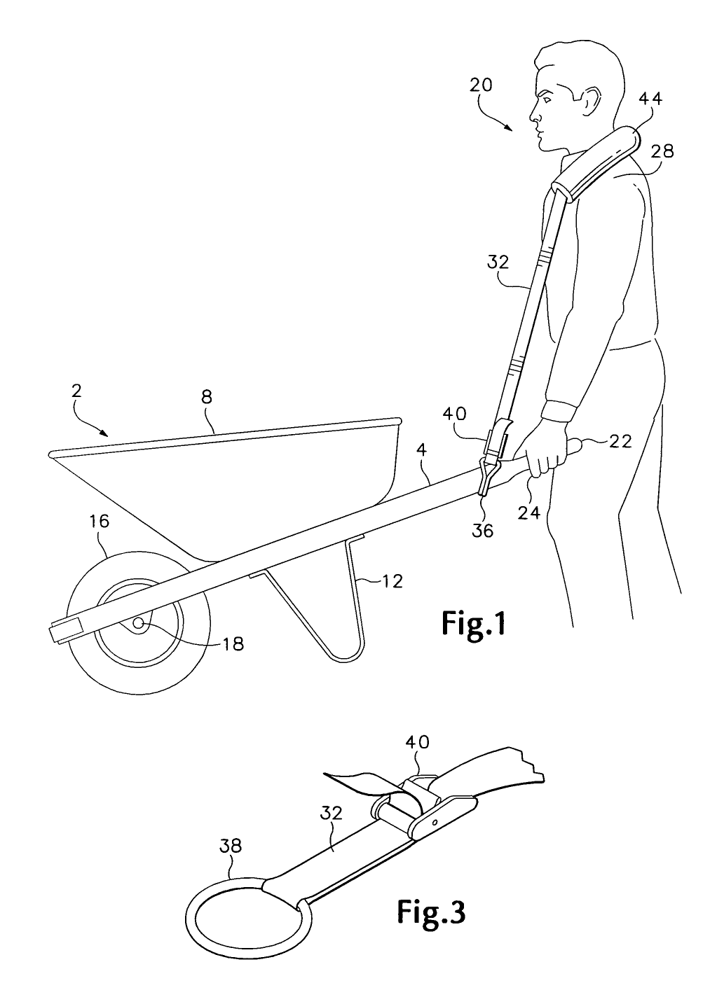

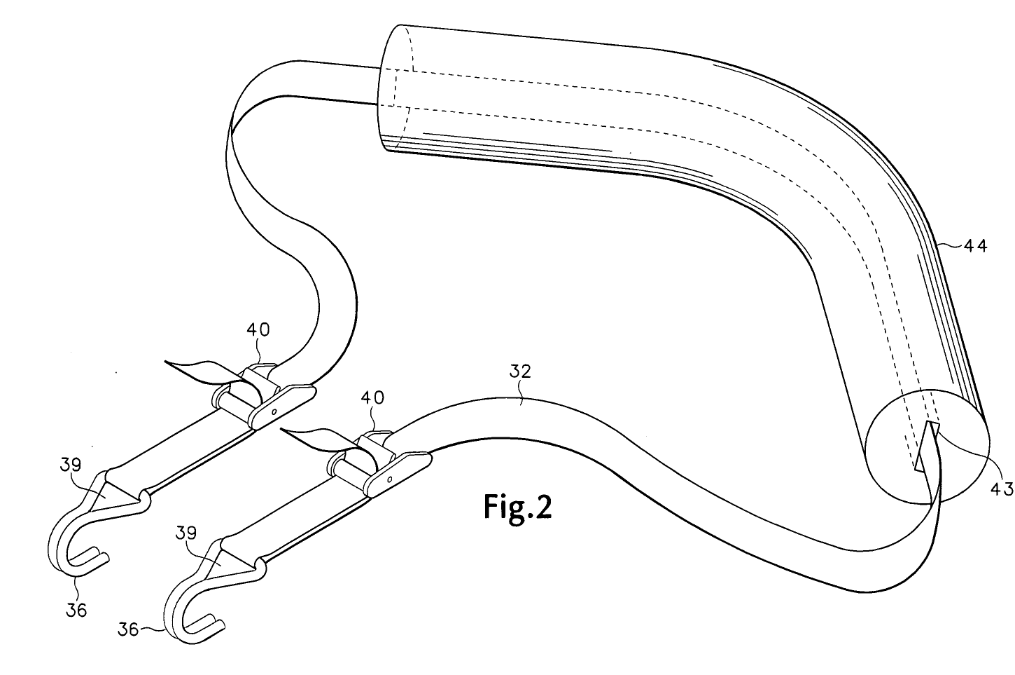

In a second embodiment of the invention, strap 32 is attached to handles 4 by means of rings 38, as shown in FIG. 3. Instead of applying the hooks from below, the operator will thread handles 4 through rings 38. The hooks 36 or rings 38 allow the operator to easily slip the lifting mechanism off handles 4.

In a third embodiment of the invention, the hook or ring is omitted and the handle is threaded through loop 52 formed in strap 32 by locking cam buckle 40, as shown in FIG. 4. FIG. 4 also illustrates additional padding 49 in central region 50 of padding 44 to provide additional protection to the operator's neck.

The illustrated embodiments of the invention are compatible with a wheelbarrow of similar design to the conventional wheelbarrow described above. The illustrated embodiments of the invention do not interfere with the operation of other conventional wheelbarrow accessories and safety devices, such as the “Wheelbarrow Braking System” described in U.S. Pat. No. 5,690,191 and the “Wheelbarrow Disk Brake Assembly” described in U.S. Pat. No. 6,443,267 or the various versions of the motorized wheelbarrows such as the “Motorized Wheelbarrow” described in U.S. Pat. No. 5,878,827 and the “Motorized Wheelbarrow” described in U.S. Pat. No. 5,465,801.

Although inexpensive to manufacture, a lifting apparatus in accordance with the invention thus allows an operator to easily lift, control and maneuver even very heavily loaded wheelbarrows and helps reduce operator fatigue.

It will be appreciated that the invention is not restricted to the particular embodiments that have been described and illustrated, and that variations may be made therein without departing from the scope of the invention as defined in the appended claims and equivalents thereof. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated.

1. An apparatus for assisting in lifting and maneuvering a wheelbarrow having first and second handles, the apparatus comprising:
a strap,
first engagement means secured to the strap for engaging the first handle of the wheelbarrow,
second engagement means secured to the strap for engaging the second handle of the wheelbarrow, and
means for adjusting a distance along the strap separating the first and second engagement means.

2. An apparatus according to claim 1, wherein the means for adjusting the distance between the first and second engagement means comprises a buckle through which the lifting strap is threaded.

3. An apparatus according to claim 1, wherein the first engagement means comprises a hook.

4. An apparatus according to claim 1, wherein the first engagement means comprises a ring.

5. An apparatus for assisting in lifting and maneuvering a wheelbarrow having first and second handles, the apparatus comprising:
a strap having a first end and a second end,
first engagement means secured to the strap for engaging the first handle of the wheelbarrow,
second engagement means secured to the strap for engaging the second handle of the wheelbarrow, and
flexible padding attached to the length of the strap.

6. An apparatus according to claim 5, wherein the flexible padding comprises a tubular length of material having a passage through which the strap is threaded.

7. An apparatus according to claim 6, wherein the passage is sufficiently large to allow the strap to freely move within the passage.

8. An apparatus according to claim 5, wherein the flexible padding has a non-uniform thickness.

9. An apparatus according to claim 5, further comprising means for adjusting a distance along the strap separating the first and second engagement means.

10. An apparatus according to claim 9, wherein the means for adjusting the distance separating the first and second engagement means comprises a buckle through which the strap is threaded.

11. An apparatus according to claim 9, wherein the means for adjusting distance between the first and second engagement means comprises a cam-buckle through which the strap is threaded.

12. An apparatus according to claim 5, wherein the first engagement means comprises a hook

13. An apparatus according to claim 5, wherein the first engagement means comprises a ring.

14. An apparatus according to claim 5, further comprising:
first locking means being lockable at a first position along the strap selected by an operator and forming a first loop in the strap,
second locking means being lockable at a second position along the strap selected by the operator and forming a second loop in the strap such that a length of the strap between the first and second loops is a function of the first and second positions.

15. An apparatus according to claim 14, wherein the first locking means comprises a cam-buckle, the strap being threaded through the cam-buckle in opposite directions to define the first loop.

16. An apparatus according to claim 14, wherein the first engagement means is secured to the strap by the first loop and the second engagement means is secured to the strap by the second loop.

17. An apparatus for assisting in lifting and maneuvering a wheelbarrow having first and second handles, the apparatus comprising:
a strap, and
first locking means through which the strap is threaded to define a first loop in the strap for engaging the first handle of the wheelbarrow.

18. An apparatus according to claim 17, further comprising a second locking means through which the strap is threaded to define a second loop in the strap for engaging the second handle of the wheelbarrow.

19. An apparatus according to claim 18, further comprising flexible padding mounted on the lifting strap between the first and second locking means.

20. An apparatus according to claim 18, wherein the flexible padding comprises a tubular length of material having a passage through which the strap is threaded wherein the passage has a cross-sectional area sufficiently large to allow the lifting strap to freely move within the passage.
